(19) United States
(12) Patent Application Publication
(10) Pub. No.: US 2020/0372077 A1
(43) Pub. Date: Nov. 26, 2020

(54) INTERACTIVE CHART RECOMMENDER

(71) Applicant: Microsoft Technology Licensing, LLC, Redmond, WA (US)

(72) Inventors: Tomasz Lukasz RELIGA, Seattle, WA (US); Manan SANGHI, Bellevue, WA (US); Alan Linchuan LIU, Seattle, WA (US); Huitian JIAO, Redmond, WA (US); Max WANG, Seattle, WA (US)

(73) Assignee: Microsoft Technology Licensing, LLC, Redmond, WA (US)

(21) Appl. No.: 16/417,010

(22) Filed: May 20, 2019

(51) Int. Cl. G06F 16/9038; G06N 20/00; G06F 16/9032; G06F 16/904; G06F 17/24

(52) U.S. Cl. CPC G06F 16/9038; G06N 20/00; G06F 17/246; G06F 16/904; G06F 16/90324

(57) ABSTRACT

Systems and methods directed to providing recommended charts are provided. More specifically, a selection of data arranged in a plurality of data series may be received and classified into series data types. Based on the series data type for each data series of the plurality of data series, a plurality of recommended charts visually describing the data may be automatically provided to a user interface, wherein each chart of the plurality of recommended charts is a different chart type visually describing the data. To provide the plurality of recommended charts, best practices and/or one or more machine learning models may be utilized. In some instances, the charts provided in the user interface may automatically change or otherwise updated based on a different selection of data and/or an assignment of a different data series type to a data series.

### BACKGROUND

A user may utilize a spreadsheet application to process and manipulate data, and using spreadsheet functions, to perform many simple to very complex calculations and organizational functions with their data. A spreadsheet application is oftentimes used for data analysis; however many of today's tools are manual, meaning that users have to stipulate what type of data they are feeding in and what type of analysis they wish to perform. In addition, users may potentially need to edit their data to conform to the needs of the tool (e.g. rearrange their data into a form recognizable by the tool, express data in a specific format, etc.). Accordingly, current approaches to data charting generally require the user to manually decide on chart type, axis type, and then manually provide the information to be displayed on the chart. That is, such approaches generally require a user to specify the chart type, axis, properties, etc. explicitly, which increases additional burden the user by requiring the user to know exactly what the right chart properties and requiring multiple clicks to obtain the correct visualization of the data. Thus, users often are required to expend a significant amount of effort between the examination of the data and the generation of the chart and consequently, gaining insight from the data.

It is with respect to these and other general considerations that examples have been described. Although relatively specific problems have been discussed, it is understood that the examples should not be limited to solving the specific problems identified in the background.

### SUMMARY

The present disclosure describes providing recommended charts based on selected data and classified data types. More specifically, a selection of data arranged in a plurality of data series may be received and classified into series data types. Based on the series data type for each data series of the plurality of data series, a plurality of recommended charts visually describing the data may be automatically provided to a user interface, wherein each chart of the plurality of recommended charts is a different chart type visually describing the data. To provide the plurality of recommended charts, best practices and/or one or more machine learning models may be utilized. In some instances, the charts provided in the user interface may automatically change or otherwise be updated based on a different selection of data and/or an assignment of a different data series type to a data series. Thus, for example, recommended charts will display updated information as soon as a user changes a selection of a data series of interest.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 is a block diagram of one example of a system for automatically providing recommended charts from a dataset to a user in accordance with examples of the present disclosure.

FIG. 2 is an illustration of a first example spreadsheet application user interface including a dataset in accordance with examples of the present disclosure.

FIG. 3 is an illustration of a second example spreadsheet application user interface including a dataset and recommended charts in accordance with examples of the present disclosure.

FIGS. 4A-4D depict example user interface layouts including datasets and recommended charts in accordance with examples of the present disclosure.

FIG. 5 depicts additional details directed to automatically providing recommend charts from a dataset to a user in accordance with examples of the present disclosure.

FIG. 6 depicts a flow chart of a method for automatically providing recommended charts from a dataset and presenting the recommend charts.

FIG. 7 depicts a block diagram illustrating example physical components of a computing device with which examples of the present disclosure may be practiced.

FIGS. 8A and 8B depict simplified block diagrams of a mobile computing device with which examples of the present disclosure may be practiced.

FIG. 9 is a simplified block diagram of a distributed computing system in which examples of the present disclosure may be practiced.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims.

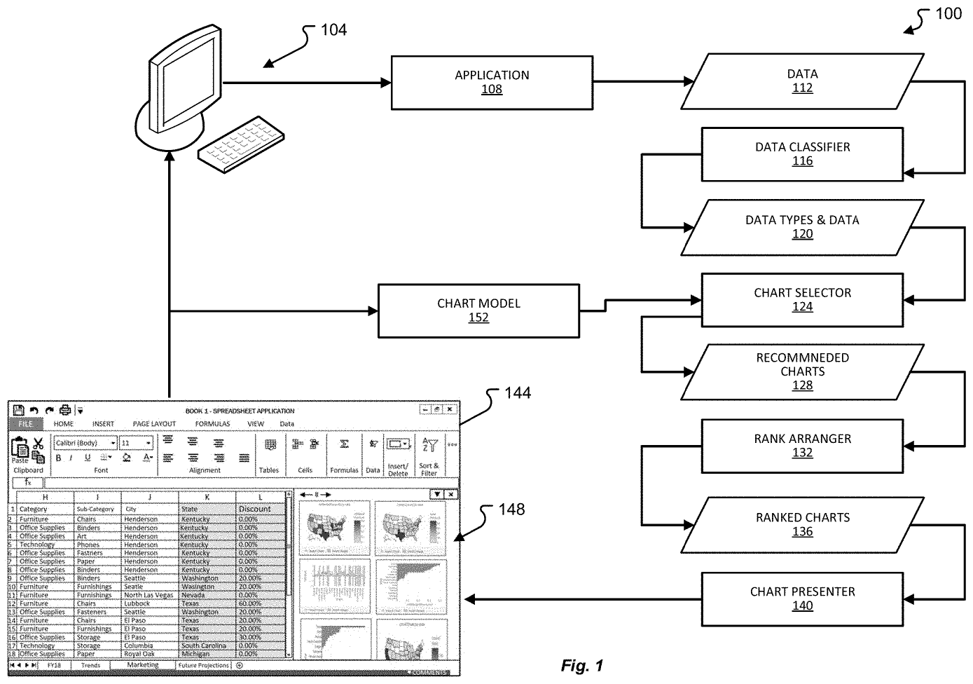

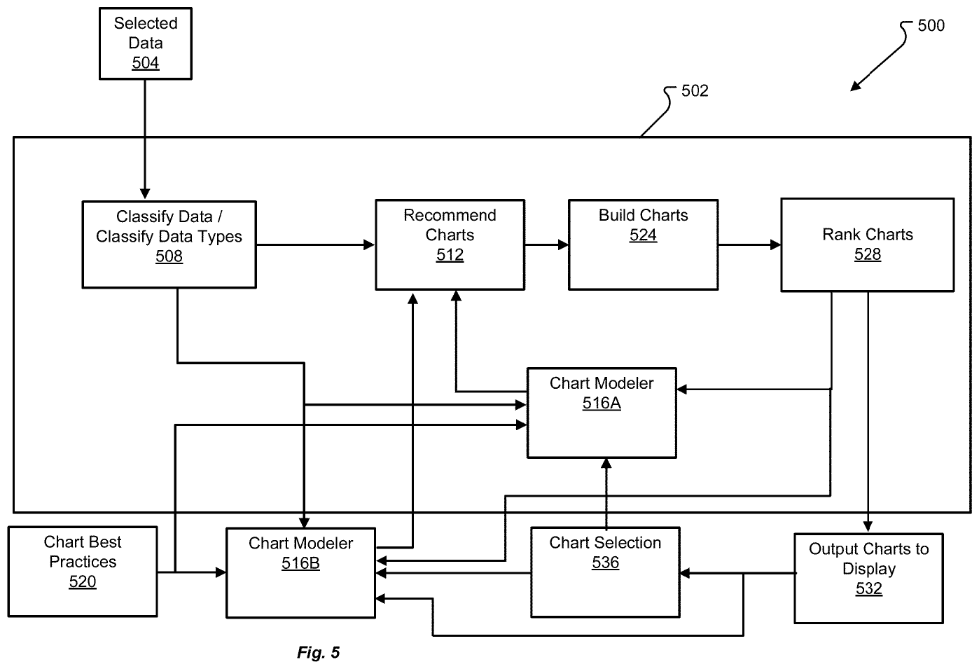

Referring now to the drawings, in which like numerals represent like elements, various examples will be described. FIG. 1 depicts a block diagram illustrating a system architecture 100 for providing one or more recommended charts based on selected datasets and best practices in accordance with examples of the present disclosure. The system architecture 100 may include a computing device 104. The computing device 104 may be one of a variety of suitable computing devices described below with reference to, but not limited to, FIGS. 5 and 7-9. For example, the computing device 104 may include a tablet computing device, a desktop computer, a mobile communication device, a laptop computer, a laptop/tablet hybrid computing device, a gaming device, or other type of computing device for executing applications 108 for performing a variety of tasks.

The application 108 illustrated in association with computing device 104 may be illustrative of any application having sufficient computer executable instructions for enabling examples of the present disclosure as described herein. For example, the application 108 may include spreadsheet applications, word processing applications, slide presentation applications, electronic mail applications, notes taking applications, desktop publishing applications, and the like. An example spreadsheet application includes Excel® manufactured by Microsoft Corporation of Redmond, Wash. As should be appreciated, this example spreadsheet application is but one example of the many applications suitable for enabling examples described herein.

The application 108 may include thick client applications, which may be stored locally on the computing device 104, or may include thin client applications (i.e., web applications) that may reside on a remote server and accessible over a network, such as the Internet or an intranet. A thin client application may be hosted in a browser-controlled environment or coded in a browser-supported language and reliant on a common web browser to render the application executable on a computing device 104.

The system architecture 100 may include data classifier 116 configured to perform operations relating to parsing the data 112, identifying types of data based on the data 112, identifying relationships between the types of data 112 and the data itself, and providing the types of data, relationships, and the data itself, as classified data 120, to the chart selector 124. For example, the data 112 may correspond to data from a plurality of selected columns, for example columns K and L of the spreadsheet application displayed in the graphical user interface 144. More specifically, the data may be grouped by column and may be provided to the data classifier 116. The data classifier 116 may receive the data 112 and identify information about the data 112. For example, the data classifier may identify a type of data as being qualitative and/or quantitative. The data classifier 116 may identify one or more of the columns, whether selected or not, as a numerical dataset, a time series, an ordinal series, a hierarchy, a specific category, etc. Additional examples of classifying data include, but are not limited to: the data classifier 116 receiving a list of dates and classifying the list of dates as a temporal type of data; the data classifier 116 receiving a list of measurements and classifying the list of measurements as a numeric type of data; and the data classifier 116 receiving a list of days of the week and classifying the list of the days of the week as categorical data. Accordingly, the data types and data 120 resulting from the data classifier may be provided to the chart selector 124.

The chart selector 124 may be operable to parse the data types and data 120 and generate a plurality of recommended charts 128. That is, the chart selector 124 may be operable to recommend a plurality of charts based on the type of data and the data itself. In some instances, heuristics and/or one or more machine learning models may be implemented to determine and then recommend the different chart types as recommended charts 128. The chart selector 124 may rely on best practices to determine the recommended chart types. In addition, one or more chart models 152 may be utilized to determine which chart should be recommended based on an analysis of the data and the classification of the data type, where the recommendation may be based on selected and/or non-selected data. In some instances, the chart model 152 may be personalized to a specific user and/or a specific type of user. For example, a user associated with an education institution may prefer a specific type of chart that may be different than a type of chart preferred by a user associated with a research institution. The chart model 152 may taking into account previous user selections of charts and/or chart types for selected data and data classifications that may be stored or otherwise utilized when selecting one or more charts to be presented to a user. Such user selections may be personalized to the user and/or may be aggregated across various users and user types.

The recommended charts 128 may then be provided to the chart arranger 132 to rank the charts in order of relevance to the data and the data types and provide the ranked charts 136 for display. In some instances, the chart arranger 132 may rank the charts based on relevance to the user and/or preferences of the user. For example, previous user selections of charts and/or chart types for selected data and data classifications may be stored or otherwise utilized when determining a ranking and arrangement for the charts that are to be presented to a user. Such user selections may be personalized to the user and/or may be aggregated across various user characteristics, users, and/or user types. In some instances, user characteristics such as but not limited to a specific user type, an organization to which the user may belong, a country and/or language associated with a user, and/or other user grouping information, may be recorded, stored, or otherwise available to influence how a chart is ranked and subsequently presented to a user. For example, a chart ranking may be different for a user that is a member of a specific organization or having an education level that is different from a user that may be a researcher, scientist, or other professional that generally works with data. In some instances, machine learning may be utilized to determine a ranking of the charts based on the selected data, classification of data, previous user(s) interaction and selection of a chart, and/or user characteristics as described above. In some instances, a previously selected chart may be utilized to determine one or more preferences of a user such that the one or more preferences influence chart ranking; in some instances, a previously selected chart from another user may be utilized to determine one or more rankings for the recommended charts. The ranked charts 136 may then be provided to the chart presenter 140, where the charts may be presented to a user in accordance with their perceived level of relevance and/or rank. As further depicted in FIG. 1, the graphical user interface 144 corresponding to a spreadsheet application, such as application 108, may display the recommended charts as 148; the recommended charts 148 may be displayed to a user alongside or in addition to the selected data, as further illustrated in the graphical user interface 144.

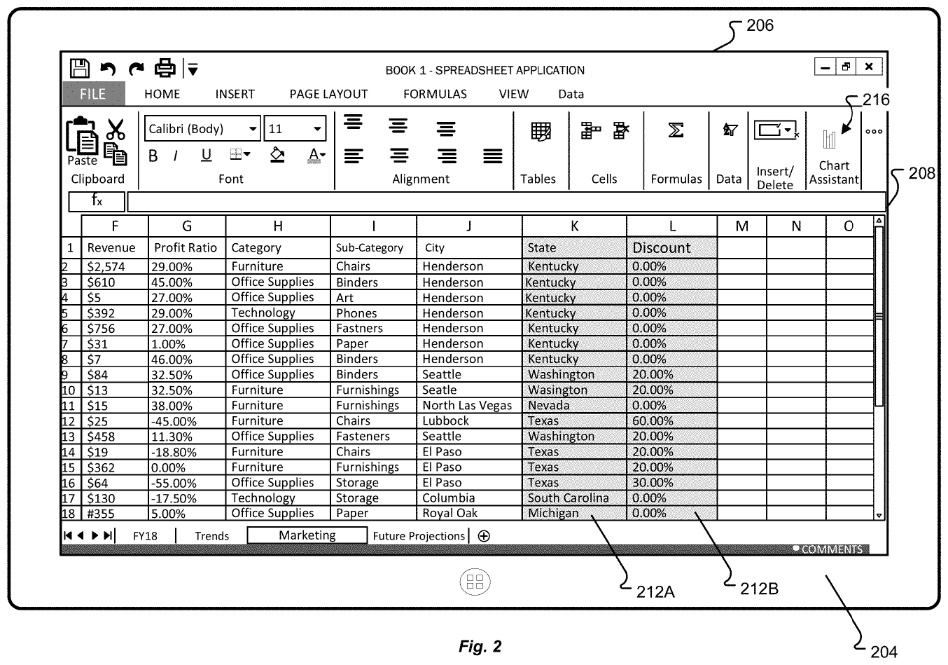

Referring now to FIG. 2, an example spreadsheet application graphical user interface 206 and spreadsheet document 208 are illustrated that may be displayed on any suitable computing device 204, where the suitable computing device 204 may be the same as or similar to one or more of the computing devices 104 previously described above. According to examples, the user interaction with the electronic spreadsheet user interface, such as the graphical user interface 206, and spreadsheet document 208 may be accomplished via a variety of interaction methods including keyboard entry, mouse entry, gesture entry, voice command, eye tracking, thin air gesture entry, electronic inking entry, and/or combinations thereof. The graphical user interface 206 and spreadsheet document 208 are for purposes of example and illustration only and are not exhaustive of the variety of types of documents that may contain data for which examples of the present invention may be utilized. For example, while examples described herein discuss automatically providing a recommended chart based on the selected data and presenting the recommended charts to a user in association with data contained in a spreadsheet document 208, other software applications and associated documents, for example, word processing documents, slide presentation documents, electronic mail documents, notes documents, and the like that are capable of receiving displaying and allowing operation of spreadsheet-type functions may be utilized in accordance with examples of the present invention.

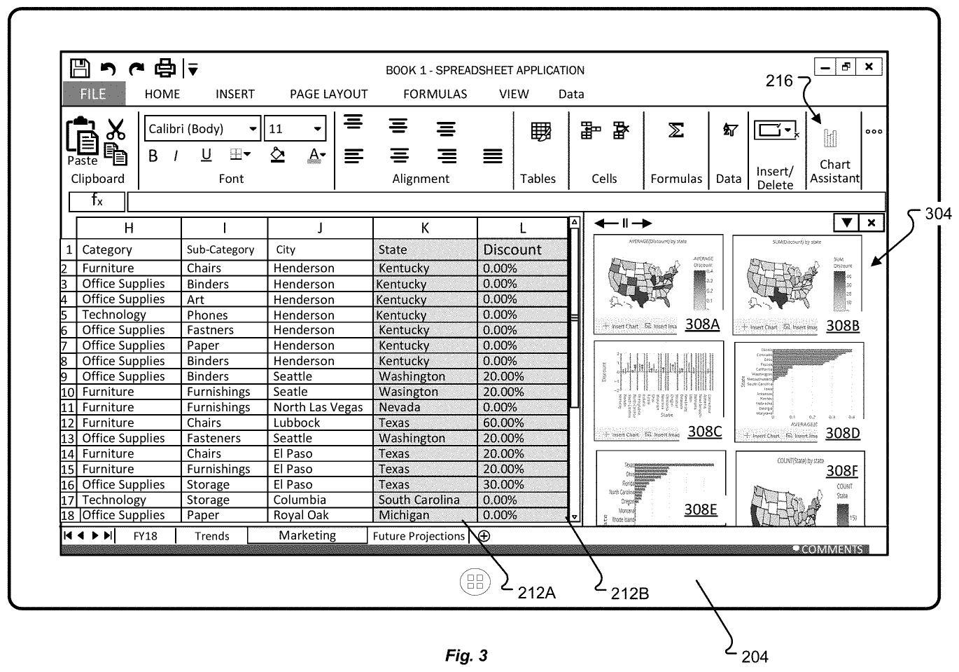

Referring still to FIG. 2, the example spreadsheet application graphical user interface 206 includes selected data 212A and 212B. In the example spreadsheet document 208, the data 212A and 212B is in a data sheet comprising a matrix of data cells containing data corresponding to geographic locations and discounts for such geographic locations. More generally, the spreadsheet document 208 includes additional information relating to the types of purchases and revenue from such purchases for a plurality of different locations. According to examples, one or more automatically generated charts may be based on the selected data 212A and/or 212B. In some instances, the one or more automatically generated charts may be based on the selected data 212A and/or 212B and additional unselected data, such as the unselected data within one or more of the columns F, G, H, I, and/or J. In examples, the selection of the data 212A and/or 212B may cause a chart assistant application, or module, to display a chart recommendation portion as illustrated in FIG. 3. Alternatively, or in addition, a user may select an icon, such as the chart assistant icon 216, to initiate a chart assistant application, or module, to display the chart recommendation portion as illustrated in FIG. 3.

As depicted in FIG. 3, one or more charts based on the selected data in column K and L, may be presented to a user in the chart recommendation portion 304. The chart recommendation portion 304 may correspond to a window, module, or area operable to display one or more recommended charts based on data selected by a user. Continuing with the previous example, based on the selected data 212A in column K and the selected data 212B in column L, the charts 308A-F may automatically be generated and provided to the graphical user interface such that a user may view thumbnails and/or smaller representations of the charts 308A-F. While illustrated as displaying six charts, it should be understood that fewer than six charts or more than six charts may be displayed, and/or a user may be able to scroll within the chart recommendation portion 304 to view additional charts; however, the top ranked charts are generally placed at or otherwise near the top of the chart recommendation portion 304. In some instances, a user may need to initiate the chart generation by selecting data 212A and 212B in one or more columns, such as columns K and L, and then selecting a chart assistant icon 216, where such charts will be automatically generated and provided to the graphical user interface.

Each of the charts displayed in the chart recommendation portion 304 may be different from one another in some manner. For instance, one of the charts may display a geographic entity, such as a country, state, and/or territory; one of the charts may be a line chart; one of the charts may be a scatter plot, one of the charts may be a bar chart; one of the charts may be a column chart; one of the charts may be a mix of a plurality of charts. That is, based on best practices, heuristics, machine learning, and/or user preferences and/or characteristics, whether explicitly specified or learned from user interaction with the application 108 for example or other applications, a type of chart may be recommended that best displays, highlights, or otherwise illustrates the selected data. In some examples, series, axes, and/or other labels may be included in the displayed charts 308A-308E. In some instances, one or more of the charts 308A-308E may display averaged, summed, or otherwise processed data.

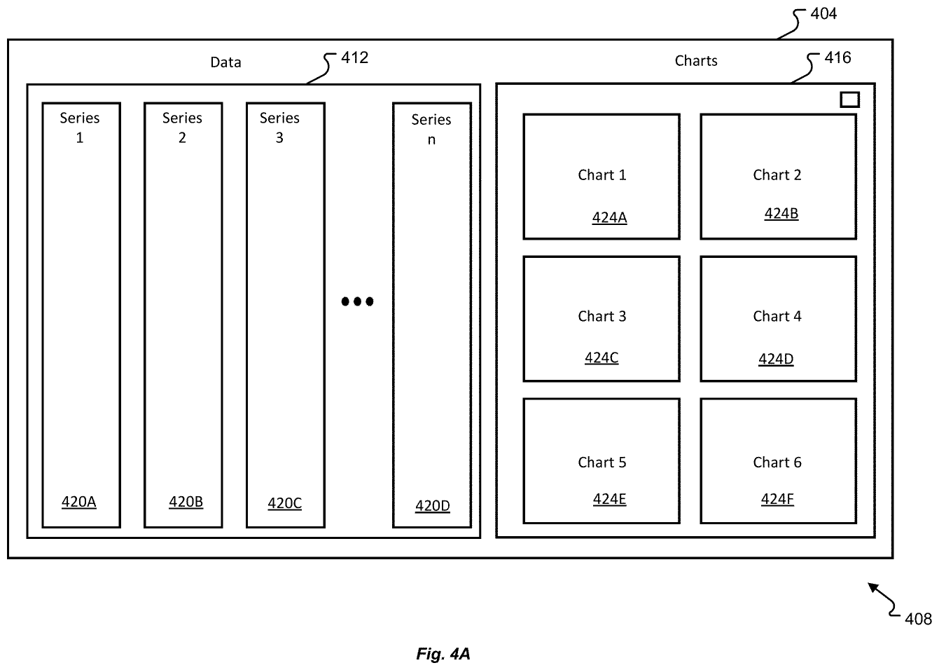

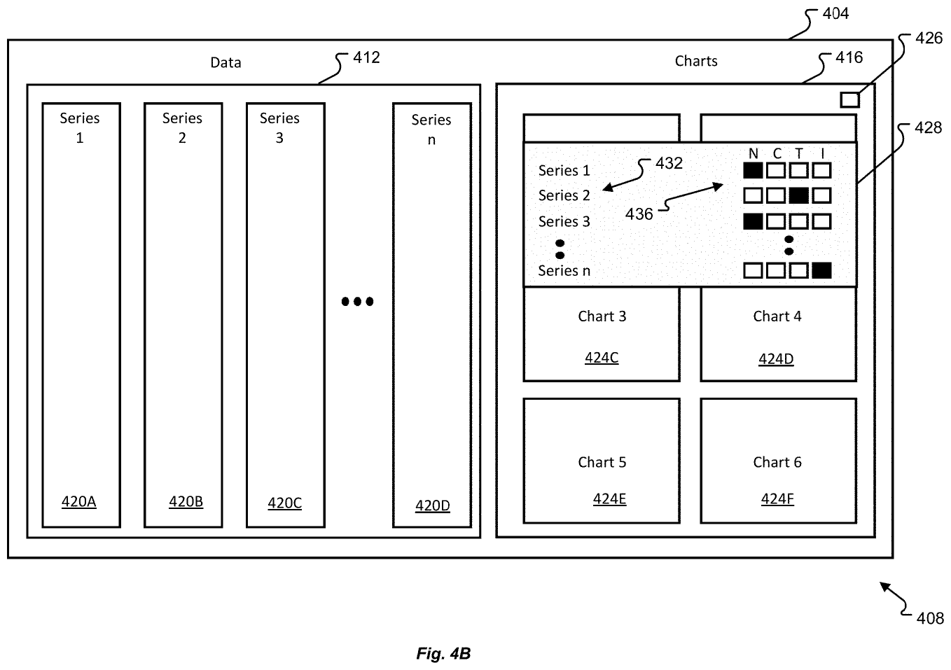

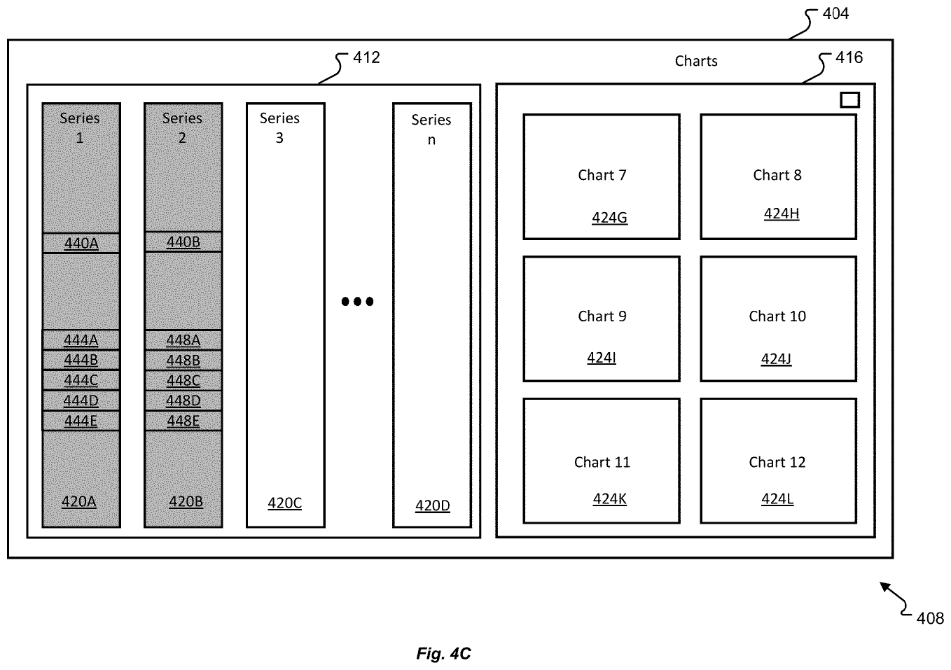

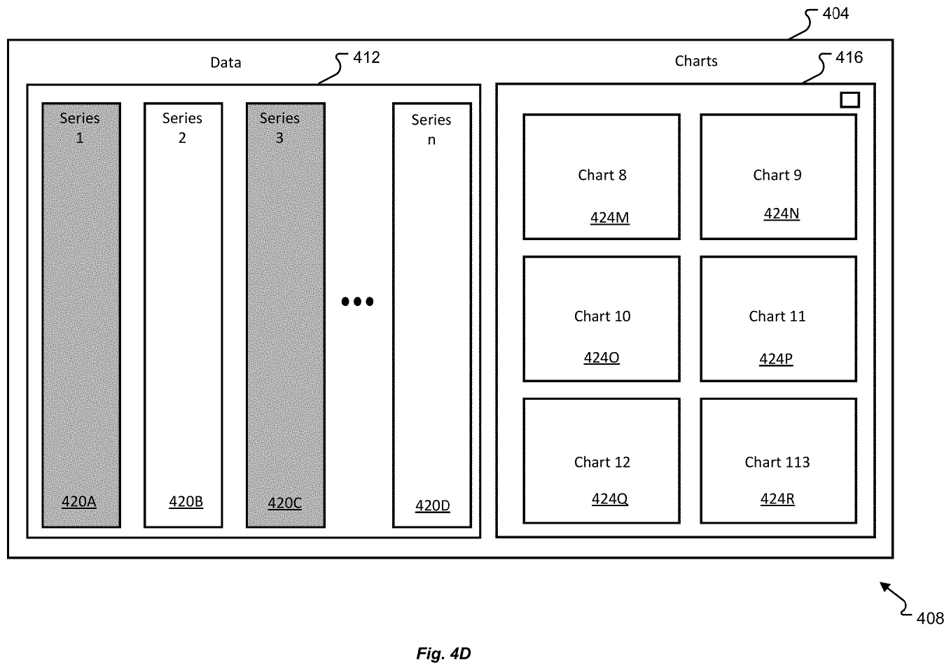

FIGS. 4A-4D depict one or more data and/or chart layouts in accordance with examples of the present disclosure. More specifically, FIG. 4A depicts a general layout of a graphical user interface 404 of a spreadsheet application 408. The graphical user interface may be the same as or similar to the previously described graphical user interface 206 and the spreadsheet application may be the same as or similar to the previously described application 108. The graphical user interface 404 may include a data portion 412 and a charts portion 416; the data portion may display or otherwise include functionality related to data included, arranged, or otherwise provided in the spreadsheet application 408. The data portion 412 may include a plurality of data series, 420A-420D, for example. Each of the data series 420A-420D may correspond to or otherwise include a type of data. As previously discussed, the data classifier 116 may receive data selected from or otherwise displayed in the data portion 412. In some instances, the data classifier 116 may receive all data or a portion of the data in the spreadsheet application 408 or otherwise accessible by the spreadsheet application. The data may then be classified by type. For example, one or more of the data series 420A-420D may be classified as categorical data; one or more of the data series 420A-420D may be automatically classified as temporal data, etc. In some instances, selected data is only classified into types; in other instance, each of the data series 420A-420D is classified into data types.

As previously discussed, each of the charts 424A-424F may be displayed in the charts portion 416; each of the charts 424A-420D may be a completed chart and/or semi-completed chart such that minimal revisions by the user may be necessary. For example, charts may be lacking titles, but otherwise axes information, series information, and/or other labels may be automatically provided based on the selected data series in the data portion 412. That is, one or more of the charts 424A-424F represent or otherwise correspond to thumbnails of the actual charts. Moreover, as a user may select different series, the data displayed in each of the charts 424A-424F may change to represent the newly selected data series. In some example, the chart types, the location of the a specific chart type, and/or any processing that may be performed on selected data series and provided in the charts portion 416 as a chart 424A-424F may change to reflect the data series selected by the user. In some instance, if no data series are selected, all data series in the spreadsheet application 408 may be provided, or otherwise, charted and displayed in multiple charts in chart portion 416.

FIG. 4B depicts additional details of the spreadsheet application 408 and the graphical user interface 404 in accordance with examples of the present disclosure. More specifically, in addition to the spreadsheet application 408 and the graphical user interface 404, the user may select an option, such as the settings option 426, which may cause or otherwise provide a window 428 to be displayed. The window 428 may include the series 432 corresponding to each of the data series in the data portion 412, and further include the associated type of information 436. For example, the type of information 436 may correspond to a numerical type (N), a categorical type (C), a temporal type (T), and/or may provide an ignore (1) option to the user. Accordingly, the user may have control over how each data series is classified into data types. Upon selecting and/or correcting the data types in the window 428, the charts in the chart portion 416 may be updated, changed, modified, or otherwise arranged to display a most highly ranked chart based on the data in the data portion 412. Alternatively, or in addition, upon selecting and/or correcting the data types in the window 428, the charts in the chart portion 416 may be updated, changed, modified, or otherwise arranged to display a most highly ranked chart based on the selected data, or selected data series, in the data portion 412.

FIG. 4C depicts additional details of the spreadsheet application 408 and the graphical user interface 404 in accordance with examples of the present disclosure. More specifically, as provided in FIG. 4C, the charts displayed in the charts portion 416 may be automatically updated and/or re-charted to match or otherwise depict charted information based on the selected data in the data portion 412. In at least one example, a data series to be charted may be selected by selecting a single cell, such as cell 440A in a first data series, and a second single cell 440B, in a second data series. Accordingly, the data in the entire data series, respective data series 420A and 420B, may proceed through the system architecture described with respect to FIG. 1, causing the recommended charts 424G-424L to be displayed in the charts portion 416. Alternatively, or in addition, a data series to be charted may be selected by selecting a plurality of cells, such as cells 444A-444E in a first data series, and a second plurality of cells, 448A-448E, in a second data series. Accordingly, the data in the entire data series, respective data series 420A and 420B, may proceed through the system architecture described with respect to FIG. 1, causing the recommended charts 424G-424L to be displayed in the charts portion 416. Alternatively, or in addition, the data in the selected cells, such as 444A-448E), may proceed through the system architecture described with respect to FIG. 1, causing the recommended charts 424G-424L to be displayed in the charts portion 416. Accordingly, the type of charts, the data depicted in the charts, and the data types depicted in the recommended charts 424G-424L may be updated in real-time, or near real-time, to display charts indicative of the selected data in the data portion 412. As another example, FIG. 4D depicts a selection of data series 420A and 420C; accordingly, recommended charts 424M-424R may be displayed in the chart portion 416. As previously discussed, each of the recommended charts 424M-424R may be a different type of chart to illustrate, based on best practices, heuristic analysis, and/or machine learning models, the selected data, for instance data in the selected data series 420A and 420C.

FIG. 5 depicts additional details of a chart recommendation system 500 in accordance with examples of the present disclosure. More specifically, FIG. 5 may include an application 502, such as a spreadsheet application previously discussed. The application 502 may receive a selection of data 504. The selection may be performed by a user by selecting, via a graphical user interface, programmatically, or otherwise, one or more data series to be charted. Accordingly, the application 502 may proceed to classify the data in the received data series at 508 and provide the classified data series to a chart recommender as previously described. Accordingly, a plurality of recommended charts may be identified at 512 based on the received selected data 540. In accordance with examples of the present disclosure, the plurality of recommended charts at 512 may be based on the selected data and one or more chart modelers 516A/516B. In examples, the chart modeler 516A/516B may receive charting best practices 520 and provide recommended charts based on the classified data and data series. In some examples, the chart modeler 516A/516B may incorporate machine learning to determine recommended charts based on the charting best practices 520, the data, and the data series types.

In examples, the application 502 may build, render, or otherwise create the recommended charts at 524 and further rank each of the charts at 528 based on best practices, most relevance to a user, a user, user preference, and/or user type. Accordingly, the ranked charts may then be displayed to the user in an interactive fashion as previously discussed at 532. As depicted in FIG. 5, the ranking of the charts at 528 may be provided to the chart modeler 516A/516B such that the chart modeler may utilize the predicted charts when providing the recommended charts at 512. Moreover, a chart selected by a user at 536, for example to insert into another application, to render as a bigger chart in the application, to print, or otherwise, may be provided to the chart modeler 516A/516B such that the chart modeler 516A/516B may take into consideration user preferences for example, when providing recommended charts at 512.

Additionally depicted in FIG. 5 are the plurality of chart modelers 516A/516B. A first chart modeler 516A may reside or otherwise be a part of the application 502 while the chart modeler 516B may reside outside of and/or external to the application 502. For example, the chart modeler 516B may reside at a network location, storage location, cloud location, and/or device that is different from which the application 502 is executed and/or the charts are displayed. For instance, the data and data series may be provided to an offsite location for analysis such that additional physical resources may be involved when providing recommended charts. In some instances, both chart modelers 516A and 516B may be present to share the process of providing recommended charts.

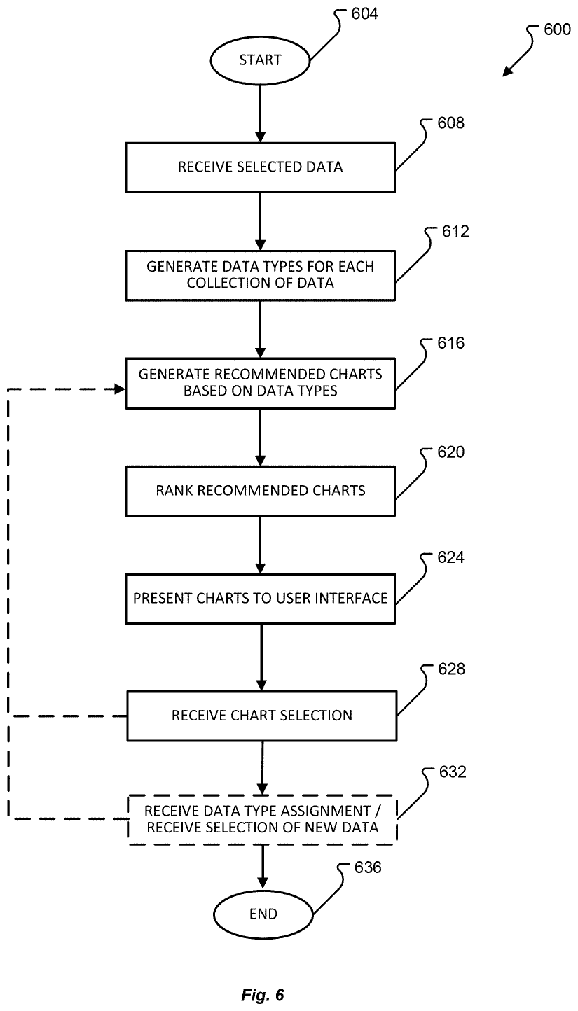

FIG. 6 illustrates a flow chart depicting one example of a method 600 for automatically recommending charts based on selected data in accordance with examples of the present disclosure. A general order for the steps of the method 600 is shown in FIG. 6. Generally, the method 600 starts with a start operation 604 and ends with the end operation 636. The method 600 may include more or fewer steps or may arrange the order of the steps differently than those shown in FIG. 6. The method 600 may be executed as a set of computer-executable instructions executed by a computer system and encoded or stored on a computer readable medium. Further, the method 600 may be performed by gates or circuits associated with a processor, Application Specific Integrated Circuit (ASIC), a field programmable gate array (FPGA), a system on chip (SOC), or other hardware device. Hereinafter, the method 600 shall be explained with reference to the systems, components, modules, software, data structures, user interfaces, etc. described in conjunction with FIGS. 1-5.

The method 600 starts at 604 and proceeds to 608 where data is received. The data received at 608 may correspond to one or more data series selected in a user interface of an application as previously described and/or may correspond to a subset of a data series as previously described. Alternatively, or in addition, the data received at 608 may correspond to one or more data series provided by the application or accessible by application and/or may correspond to a subset of a data series. At 612, the received data may be classified into one or more types of data, such as categorical, numerical, temporal, and the like. Thus, for each data series, a type of data may be generated and/or configured or set such that chart recommendations may be made base on the data series type and the data. At 616, and based on the type of data classified for each data series and the data itself, one or more charts may be recommended. For example, based on a heuristic analysis of the data, machine learning, or otherwise, and further based on charting best practices, one or more charts best determined to depict the selected data may be generated or otherwise determined. At 620, the recommended charts may be ranked according to a perceived importance of the user, a user profile, a user type, and/or other information generally indicative of how best the chart displays data for an intended user, operation, and/or purpose. At 624, the charts may be provided to a user, for example, in a graphical user interface 206 of an application 108 and/or the charts portion 416.

At 628, the method 600 may detect a selection of one of the presented charts for further interaction and/or other display to a user. In some examples, the selection of the chart at 628 may be provided to 616 such that future, or subsequent chart recommendations may take into account a previous recommendation for data and types of data. At 632, in some instances, a user may reclassify one or more data series such that the type of data is changed. For example, a type of data may be changed from a temporal to a categorical type of data. Accordingly, one or more recommended charts may be generated at 616 based on this data type change. In some examples, a user may select additional, different, or less data for charting; accordingly, and in an interactive fashion, the method 600 may start again at 608 to determine a plurality of charts to display to a user. The method 600 may end at 636.

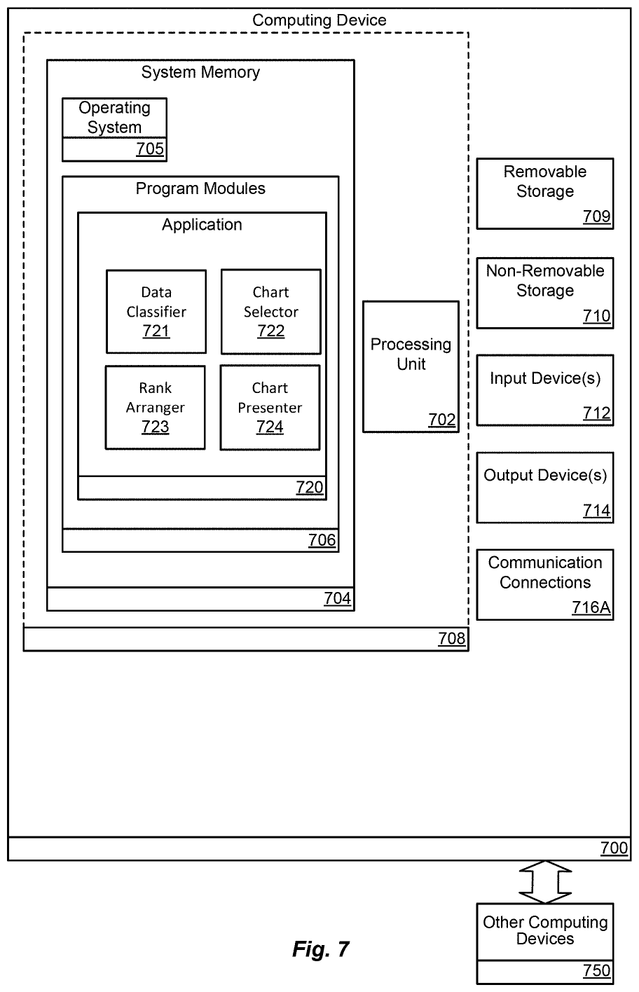

FIG. 7 is a block diagram illustrating physical components (e.g., hardware) of a computing device 700 with which aspects of the disclosure may be practiced. The computing device components described below may be suitable for the computing devices, such as the computing device 104 as described above. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for performing the various aspects disclosed herein such as the data classifier 721, the chart selector 722, the rank arranger 723, and the chart presenter 724, and/or the one or more applications 720. The operating system 705, for example, may be suitable for controlling the operation of the computing device 700. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the at least one processing unit 702, the program modules 706 (e.g., one or more applications 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716A allowing communications with other computing devices 750. Examples of suitable communication connections 716A include, but are not limited to, radio frequency (RF) transmitter, receiver, and/or transceiver circuitry; universal serial bus (USB), parallel, network interface card, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

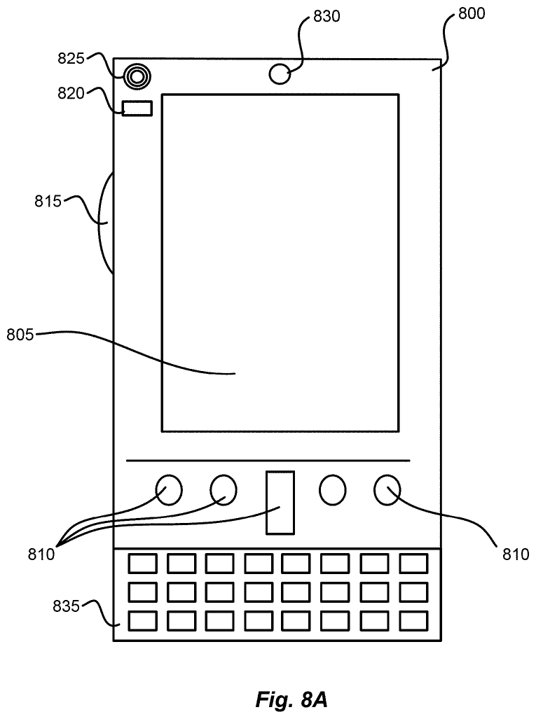

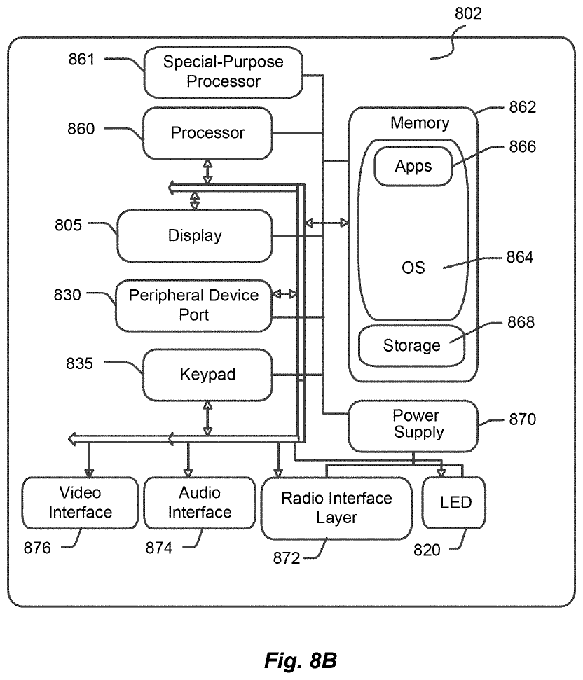

FIGS. 8A and 8B illustrate a computing device, client device, or mobile computing device 1000, for example, a mobile telephone, a smart phone, wearable computer (such as a smart watch), a tablet computer, a laptop computer, and the like, with which aspects of the disclosure may be practiced. In some aspects, the client device (e.g., 116A-116E) may be a mobile computing device. With reference to FIG. 10A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some aspects. In yet another alternative aspect, the mobile computing device 800 is a portable phone system, such as a cellular phone. The mobile computing device 800 may also include an optional keypad 835. Optional keypad 835 may be a physical keypad or a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external source.

FIG. 8B is a block diagram illustrating the architecture of one aspect of computing device or a mobile computing device (e.g., computing device 104). That is, the mobile computing device 800 can incorporate a system 802 (e.g., an architecture) to implement some aspects. The system 802 can implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, title content, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein (e.g., search engine, extractor module, relevancy ranking module, answer scoring module, etc.).

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated configuration, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with aspects of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

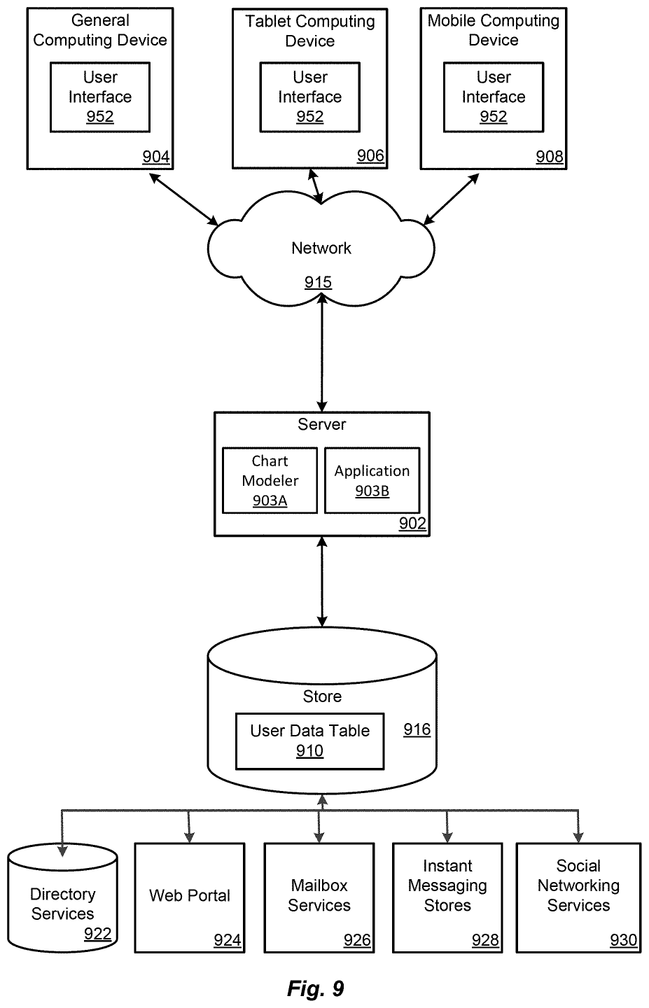

FIG. 9 illustrates one aspect of the architecture of a system for processing data received at a server device 902 (e.g., including a chart modeler 903A and/or an application 903B) from a remote source, as described above. Content at a server device 902 may be stored in different communication channels or other storage types. For example, images, or files may be stored using a directory service 922, a web portal 94, a mailbox service 926, an instant messaging store 928, or a social networking site 930. A unified profile API based on the user data table 910 may be employed by a client that communicates with server device 902. The server device 902 may provide data to and from a client computing device such as the computing device 104 through a network 1115. By way of example, the computing device 104 described above may be embodied in a personal computer 904, a tablet computing device 906, and/or a mobile computing device 908 (e.g., a smart phone) as depicted in FIG. 9. Any of these configurations of the computing devices may obtain content, images, or files from the store 916.

The above specification, examples and data provide a complete description of the manufacture and use of the composition of the invention. Since many aspects of the invention can be made without departing from the spirit and scope of the invention, the invention resides in the claims hereinafter appended.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Any of the steps, functions, and operations discussed herein can be performed continuously and automatically.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions that may be implemented with particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

In accordance with examples of the present disclosure, a computer storage media containing computer executable instructions is provided. The instructions, which when executed by a computer, perform a method for providing recommended charts. The method may include receiving a selection of data arranged in a plurality of data series, classifying each data series of the plurality of data series into a series data type, and based on the series data type for each data series of the plurality of data series, providing a plurality of recommended charts visually describing the data, wherein each chart of the plurality of recommended charts is a different chart type.

At least one aspect of the above example may further include performing a machine learning analysis utilizing one or more machine learning models to classify each data series of the plurality of data series into the series data type, performing the machine learning analysis utilizing the one or more machine learning models to rank each chart of the plurality of recommended charts, and displaying, at a graphical user interface, each chart of the plurality of recommended charts in accordance with each chart's respective ranking. At least one aspect of the above example may further include receiving a selection of a first chart of the plurality of recommend charts, and updating the one or more machine learning models based on the received selection. At least one aspect of the above example may further include presenting the data in a first portion of a graphical user interface, and presenting the plurality of recommend charts in a second portion of the graphical user interface, wherein the first portion of the graphical user interface is adjacent to the second portion of the graphical user interface. At least one aspect of the above example may further include receiving a second selection of data arranged in a plurality of data series, and based on the series data type for each data series of the plurality of data series associated with the second selection of data, updating the second portion of the graphical user interface to present a second plurality of recommended charts, wherein the second plurality of recommended charts are different than the plurality of recommended charts previously displayed in the second portion of the graphical user interface. At least one aspect of the above example may include where the second selection of data is a subset of the data. At least one aspect of the above example may further include receiving an indication to change a series data type corresponding to a first data series of the plurality of data series, and based on the changed series data type, updating the second portion of the graphical user interface to present a second plurality of recommended charts, wherein the second plurality of recommended charts are different than the plurality of recommended charts previously displayed in the second portion of the graphical user interface. At least one aspect of the above example may further include displaying a label associated with each data series, and displaying an indication of the corresponding data series type adjacent to the respective label. At least one aspect of the above example may include where the recommended charts include a label for one or more chart axis, and a label for one or more of the data series. At least one aspect of the above example may include where the chart type may be associated with at least one of a line chart, scatter plot, column chart, bar chart, or geographic chart. At least one aspect of the above example may include where the plurality of recommended charts is based on the series data type and one or more best practices for presenting data in a graphical form.

In accordance with at least one example of the present disclosure, a system for providing recommended charts is provided. The system may include one or more processors, and a memory coupled to the one or more processors, where the one or more processors operable to receive data arranged in a plurality of data series, classify one or more data series of the plurality of data series into one or more series data types, and based on the received data arranged in the plurality of data series and a subset of the one or more series data types for the one or more data series of the plurality of data series, provide a plurality of recommended charts visually describing the data, wherein each chart of the plurality of recommended charts is a different chart type.

At least one aspect of the above example may include where the one or more processors are operable to provide the plurality of recommended charts to a computing device that is different from the system including the one or more processors. At least one aspect of the above example may include where the one or more processors are operable to perform a machine learning analysis utilizing one or more machine learning models to classify the one or more data series of the plurality of data series into the series data types, perform the machine learning analysis utilizing the one or more machine learning models to rank each chart of the plurality of recommended charts, and provide each chart of the plurality of recommended charts to the computing device. At least one aspect of the above example may include where the one or more processors are operable to receive a selection of a first chart of the plurality of recommend charts, and update the one or more machine learning models based on the received selection. At least one aspect of the above example may include where the one or more processors are operable to present the data in a first portion of a graphical user interface, present the plurality of recommend charts in a second portion of the graphical user interface, wherein the first portion of the graphical user interface is adjacent to the second portion of the graphical user interface, receive a selection of data arranged in a plurality of data series, and based on the series data type for each data series of the plurality of data series associated with the selection of data, update the second portion of the graphical user interface to present a second plurality of recommended charts, wherein the second plurality of recommended charts are different than the plurality of recommended charts previously displayed in the second portion of the graphical user interface.

In accordance with at least one example of the present disclosure, a method for providing recommended charts is provided. The method may include receiving a selection of first data arranged in a plurality of data series, classifying each data series of the plurality of data series into a series data type, wherein the series data type for each data series of the plurality of data series is classified as one or more of a numerical dataset, a time series, an ordinal series, a hierarchy, or a category, analyzing the data and producing second data corresponding to but different from the first data, and based on the series data type for each data series of the plurality of data series and the second data, providing a plurality of recommended charts visually describing the second data, wherein each chart of the plurality of recommended charts is a different chart type.

At least one aspect of the above example may further include performing a machine learning analysis utilizing one or more machine learning models to classify each data series of the plurality of data series into the series data type, performing the machine learning analysis utilizing the one or more machine learning models to produce the second data, performing the machine learning analysis utilizing the one or more machine learning models to rank each chart of the plurality of recommended charts, and displaying, at a graphical user interface, each chart of the plurality of recommended charts in accordance with each chart's respective ranking. At least one aspect of the above example may further include providing the plurality of recommend charts to a computing device. At least one aspect of the above example may further include presenting the first data in a first portion of a graphical user interface, and presenting the plurality of recommend charts in a second portion of the graphical user interface, wherein the first portion of the graphical user interface is adjacent to the second portion of the graphical user interface.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer storage media containing computer executable instructions which, when executed by a computer, perform a method for providing recommended charts, the method comprising:
receiving a selection of data arranged in a plurality of data series;
classifying each data series of the plurality of data series into a series data type; and
based on the series data type for each data series of the plurality of data series, providing a plurality of recommended charts visually describing the data, wherein each chart of the plurality of recommended charts is a different chart type.

2. The method of claim 1, further comprising:
performing a machine learning analysis utilizing one or more machine learning models to classify each data series of the plurality of data series into the series data type;
performing the machine learning analysis utilizing the one or more machine learning models to rank each chart of the plurality of recommended charts; and
displaying, at a graphical user interface, each chart of the plurality of recommended charts in accordance with each chart's respective ranking.

3. The method of claim 2, further comprising:
receiving a selection of a first chart of the plurality of recommend charts; and
updating the one or more machine learning models based on the received selection.

4. The method of claim 1, further comprising:
presenting the data in a first portion of a graphical user interface; and
presenting the plurality of recommend charts in a second portion of the graphical user interface, wherein the first portion of the graphical user interface is adjacent to the second portion of the graphical user interface.

5. The method of claim 4, further comprising:
receiving a second selection of data arranged in a plurality of data series; and
based on the series data type for each data series of the plurality of data series associated with the second selection of data, updating the second portion of the graphical user interface to present a second plurality of recommended charts, wherein the second plurality of recommended charts are different than the plurality of recommended charts previously displayed in the second portion of the graphical user interface.

6. The method of claim 5, wherein the second selection of data is a subset of the data.

7. The method of claim 4, further comprising:
receiving an indication to change a series data type corresponding to a first data series of the plurality of data series; and
based on the changed series data type, updating the second portion of the graphical user interface to present a second plurality of recommended charts, wherein the second plurality of recommended charts are different than the plurality of recommended charts previously displayed in the second portion of the graphical user interface.

8. The method of claim 7, further comprising:
displaying a label associated with each data series; and
displaying an indication of the corresponding data series type adjacent to the respective label.

9. The method of claim 1, wherein the recommended charts include a label for one or more chart axis, and a label for one or more of the data series.

10. The method of claim 1, wherein the chart type may be associated with at least one of a line chart, scatter plot, column chart, bar chart, or geographic chart.

11. The method of claim 1, wherein the plurality of recommended charts is based on the series data type and one or more best practices for presenting data in a graphical form.

12. A system for providing recommended charts, the system comprising:
one or more processors; and
a memory coupled to the one or more processors, the one or more processors operable to:
receive data arranged in a plurality of data series;
classify one or more data series of the plurality of data series into one or more series data types; and
based on the received data arranged in the plurality of data series and a subset of the one or more series data types for the one or more data series of the plurality of data series, provide a plurality of recommended charts visually describing the data, wherein each chart of the plurality of recommended charts is a different chart type.

13. The system of claim 12, wherein the one or more processors are operable to:
provide the plurality of recommended charts to a computing device that is different from the system including the one or more processors.

14. The system of claim 13, wherein the one or more processors are operable to:
perform a machine learning analysis utilizing one or more machine learning models to classify the one or more data series of the plurality of data series into the series data types;
perform the machine learning analysis utilizing the one or more machine learning models to rank each chart of the plurality of recommended charts; and
provide each chart of the plurality of recommended charts to the computing device.

15. The system of claim 14, wherein the one or more processors are operable to:
receive a selection of a first chart of the plurality of recommend charts; and
update the one or more machine learning models based on the received selection.

16. The system of claim 12, wherein the one or more processors are operable to:
present the data in a first portion of a graphical user interface;
present the plurality of recommend charts in a second portion of the graphical user interface, wherein the first portion of the graphical user interface is adjacent to the second portion of the graphical user interface;
receive a selection of data arranged in a plurality of data series; and
based on the series data type for each data series of the plurality of data series associated with the selection of data, update the second portion of the graphical user interface to present a second plurality of recommended charts, wherein the second plurality of recommended charts are different than the plurality of recommended charts previously displayed in the second portion of the graphical user interface.

17. A method for providing recommended charts, the method comprising:
receiving a selection of first data arranged in a plurality of data series;
classifying each data series of the plurality of data series into a series data type, wherein the series data type for each data series of the plurality of data series is classified as one or more of a numerical dataset, a time series, an ordinal series, a hierarchy, or a category;
analyzing the data and producing second data corresponding to but different from the first data; and
based on the series data type for each data series of the plurality of data series and the second data, providing a plurality of recommended charts visually describing the second data, wherein each chart of the plurality of recommended charts is a different chart type.

18. The method of claim 17, further comprising:
performing a machine learning analysis utilizing one or more machine learning models to classify each data series of the plurality of data series into the series data type;
performing the machine learning analysis utilizing the one or more machine learning models to produce the second data;
performing the machine learning analysis utilizing the one or more machine learning models to rank each chart of the plurality of recommended charts; and
displaying, at a graphical user interface, each chart of the plurality of recommended charts in accordance with each chart's respective ranking.

19. The method of claim 17, further comprising:
providing the plurality of recommend charts to a computing device.

20. The method of claim 17, further comprising:
presenting the first data in a first portion of a graphical user interface; and
presenting the plurality of recommend charts in a second portion of the graphical user interface, wherein the first portion of the graphical user interface is adjacent to the second portion of the graphical user interface.
